(19) United States
(12) Patent Application Publication
(10) Pub. No.: US 2013/0245818 A1
(43) Pub. Date: Sep. 19, 2013

(54) LOGISTICS INSTALLATION FOR A RACK STORAGE SYSYEM

(71) Applicant: LTW INTRALOGISTICS GMBH, Wolfurt (AT)

(72) Inventors: KONRAD EBERLE, BREGENZ (AT); URS GERBER, BREGENZ (AT)

(73) Assignee: LTW INTRALOGISTICS GMBH, WOLFURT (AT)

(21) Appl. No.: 13/845,323

(22) Filed: Mar. 18, 2013

(30) Foreign Application Priority Data
Mar. 16, 2012 (AT) AT A319/2012

(51) Int. Cl. G05B 19/418

(52) U.S. Cl. CPC G05B 19/4189
USPC 700/228

(57) ABSTRACT

A logistics installation for a high-rack storage system has a plurality of conveyor vehicles that travel along a reference track section. A control device is enabled to block a given region of the reference section for travel by a second conveyor vehicle depending on a measured position of a first conveyor vehicle along the reference section. A device for determining a direction of movement of the conveyor vehicles transmits a corresponding signal to the control device. The region that is blocked for the second conveyor vehicle can be established by the control device with regard to the signal representing the direction of movement of the first conveyor vehicle.

The invention concerns a logistics installation for a rack storage system. The invention also concern a rack storage system with such a logistics installation and a method of movement control of conveyor vehicles in a logistics installation.

There are already the most widely varying systems in the field of rack storage systems and control for conveyor vehicles in such rack storage systems. What is important in that respect is to provide for quick efficient conveyance of storage goods and at the same time to guarantee a high level of safety in relation to a plurality of conveyor vehicles moving in the rack storage system.

A possible way of controlling the conveyor vehicles in the rack storage systems is that this is implemented by way of a material flow computer, in which respect it is doubtful whether technically this can be implemented at all. That control is performed on a higher-order storage system management level. The movement of each individual conveyor vehicle is then dependent on that material flow computer. That kind of movement control however affords an excessively low safety level. To integrate collision avoidance in such a material flow computer a very high degree of computing complication and expenditure would be necessary, which rises exponentially with the number of conveyor vehicles and is thus uneconomical in particular in the case of large rack storage systems.

In order for such a complicated and expensive collision safeguard arrangement not to be integrated directly into that storage management level, light barrier arrangements can also be provided at the rack servicing devices so that they can recognise each other. If recognition occurs and thus a collision was just avoided then the conveyor vehicle has to be manually driven free however by a storage system operator. That is highly complicated and leads to serious delays in the case of highly automated rack storage systems. There is also the disadvantage that such light barrier arrangements can only be limitedly used in an area involving a curve or an area involving switching points as they do not have a full view over the entire curve or switching points region. As an example in that respect attention is directed to U.S. Pat. No. 7,711,446 B2 disclosing a transport apparatus for use in a rack storage system, wherein each vehicle has a distance sensor. In addition there is also an on-board controller by way of which the speed can be calculated.

A further kind of logistics installation is known from EP 1 547 945 A2. Therein the entire displacement section—which inter alia has a plurality of points switching regions—of the conveyor vehicles is subdivided into individual position fields and when a conveyor vehicle travels into such a position field that region is blocked for another conveyor vehicle. That therefore always involves a comparison of the absolute position of the conveyor vehicles. A disadvantage with this logistics installation control system is that a plurality of regions are always blocked at the same time. In addition individual blocked regions are often relatively large, whereby many fields are blocked to conveyor vehicles although the risk of a collision would not yet apply, because of the large distance.

In addition, the state of the art discloses collision prevention devices for substantially straight displacement sections with a defined starting point and a defined end point. They are therefore totally unsuitable for collision prevention in a switching points region. An example of this is U.S. Pat. No. 5,634,565 disclosing a method of collision prevention between loading cranes by speed regulation. Inter alia a risk factor is also calculated and, on the basis thereof, a safety margin. There is only a single section (parallel running rails) on which the total of three cranes move.

In addition in this respect attention is directed to GB 2 205 463 A also disclosing a collision prevention system in which the direction of movement and the speed are taken into consideration for collision safeguard. At a low speed the safety margins can be correspondingly reduced whereby respective other devices can continue to move unhinderedly, even in relative proximity to each other. Such an arrangement cannot provide for adequate collision safeguard when used in a switching points region.

Therefore the object of the present invention is to provide a logistics installation which is improved over the state of the art. In particular the invention seeks to make a more efficient displacement of the conveyor vehicles possible. In addition the invention seeks to provide that the conveyor vehicles can be moved as closely to each other as possible. The invention further seeks to reliably prevent collisions in the switching points region.

That is achieved for a logistics installation with the features of claim 1. Accordingly it is provided that at least a first and a second conveyor vehicle travel along a reference section, wherein the reference section has at least one switching points region. In addition there is provided a control device by which a given region of the reference section can be blocked for travel by the second conveyor vehicle in dependence on a measured position of the first conveyor vehicle along the reference section, wherein when the first conveyor vehicle travels into the switching points region the switching points region is blocked in particular completely for the second conveyor vehicle. This therefore ensures that no collision between the conveyor vehicles occurs in the switching points region by virtue of the at least three converging section portions. In addition according to the invention there is further provided a device for determining the direction of movement of the conveyor vehicles by which a signal—representing the direction of movement of the conveyor vehicles—can be passed to the control device, wherein the region blocked for the second conveyor vehicle can be established by the control device having regard to the signal representing the direction of movement of the first conveyor vehicle. Thus no absolute field is blocked at least outside the switching points regions but in dependence on the direction of movement a region around the respective conveyor vehicle is always blocked for other conveyor vehicles.

If the reference section has a switching points region, wherein the switching points region is at least partially blocked for the second conveyor vehicle when the first conveyor vehicle travels into the switching points region, that gives the advantage that not only a substantially straight section is safeguarded against collision, but also the substantially more hazardous switching points region. The invention thus affords a dual safeguard: on the one hand a speed- and position-dependent collision safeguard between the conveyor vehicles and on the other hand additional and separate collision protection in the switching points region.

It can be provided that the entire switching points region is blocked for every other conveyor vehicle as soon as a conveyor vehicle is in the switching points region. To achieve more efficient utilization of the overall logistics installation however it is preferably provided that the region blocked for the second conveyor vehicle in the switching points region can be varied, in particular reduced in size, in dependence on the signal representing the direction of movement of the first conveyor vehicle. In other words, when two conveyor vehicles travel in succession in the switching points region—in particular in the change aisle of the switching points region—then both conveyor vehicles can be simultaneously disposed in the blocked region. Thus blocking of the switching points region is removed for another conveyor vehicle only when there is no risk of a collision on the basis of the signals representing the direction of movement of the two conveyor vehicles. Those signals—if they are “positive”—are thus of a higher order than the switching points region blocking signal.

Naturally not just one such conveyor vehicle can be provided in a logistics installation, but preferably the control device controls each conveyor vehicle in the logistics installation in dependence of that movement direction collision safeguard. In other words each conveyor vehicle has blocking regions which travel therewith “like a shadow” and which upon overlapping prevent mutual approaching travel movement and thus prevent a collision.

It is possible for the given blocked region to be around the conveyor vehicle or laterally and in front of same. It is preferably provided however that the given blocked region is preferably only in front of the first conveyor vehicle in the direction of movement.

Theoretically the control device can be integrated into a higher-order material flow computer or can also be integrated into one of the conveyor vehicles. It is preferably provided however that the control device is arranged in a stationary control cabinet. The individual conveyor vehicles are preferably controlled by way of radio signals from that stationary control cabinet.

For ascertaining the positions of the conveyor vehicles there is preferably provided a measuring system by which the position of the conveyor vehicles along the reference section can be measured. A rail, a barcode strip, a laser or the like can serve as the reference section. It is further preferably provided that the direction of movement of the first conveyor vehicle can be ascertained from at least two positions measured successively, preferably by the measuring system, of the first conveyor vehicle.

The device for determining the direction of movement of the conveyor vehicles can be directly integrated into each conveyor vehicle. It is preferably provided however the device for determining the direction of movement of the conveyor vehicles is a logic component of the control device.

To achieve still more efficient adaptation of the individual blocking regions it is preferably provided that the speed of the first conveyor vehicle can be calculated, preferably measured, by the control device from at least two positions of the first conveyor vehicle, that are measured in succession at regular time intervals, preferably by the measuring system, wherein the length of the given blocked region can be calculated in dependence on said calculated speed. Thus the size of the blocking region is not always the same but is calculated in dependence on the speed. In that way absolute blocking of a region does not have to be effected but it is also possible to effect a reduction in the speed of the conveyor vehicles. In other words, the closer a conveyor vehicle is to a crossing point or to another conveyor vehicle, the correspondingly slower becomes the permissible speed. The present invention thus forms a kind of blocking circle around each vehicle, travelling therewith, the size of the circle additionally being dependent on speed.

It is preferably provided that the position of each conveyor vehicle is continuously measured by the measuring system. In that respect continuously means that regular position monitoring, preferably in the millisecond range, is effected.

Preferably rack servicing devices constitute the conveyor vehicles. It will be noted however that conveyor vehicles can also be vertical conveyors, self-propelled travel carriages or electrically operated suspended carriages. Preferably the conveyor vehicles are rail-guided but they can also travel rail-less, for example along magnetic guide sections.

Protection is also claimed for a rack storage system, in particular a high-bay rack storage system, with a logistics installation according to the invention.

Protection is also claimed for a method of controlling movement of conveyor vehicles in a logistics installation comprising the steps which can be performed by a control device: measuring the position of a first conveyor vehicle along a reference section, measuring or calculating the direction of movement of the first conveyor vehicle along the reference section, blocking a region along the reference section for a second conveyor vehicle in dependence on the direction of movement of the first conveyor vehicle, and optionally blocking a switching points region of the reference section for a second conveyor vehicle when a first conveyor vehicle is already in the switching points region. It can preferably also be provided in such a method that blocking of a region along the reference section is also effected in dependence on the speed of at least one conveyor vehicle.

To achieve a control method which is as efficient as possible it is preferably further provided that in dependence on the direction of movement and the speed of both conveyor vehicles a region is blocked along the reference section before the respective conveyor vehicle, wherein with overlapping of the regions of both conveyor vehicles mutual blocking of the regions and/or a reduction in speed of the conveyor vehicles is triggered.

Further details and advantages of the present invention are described in greater detail hereinafter by means of the specific description with reference to the embodiments by way of example illustrated in the drawings in which:

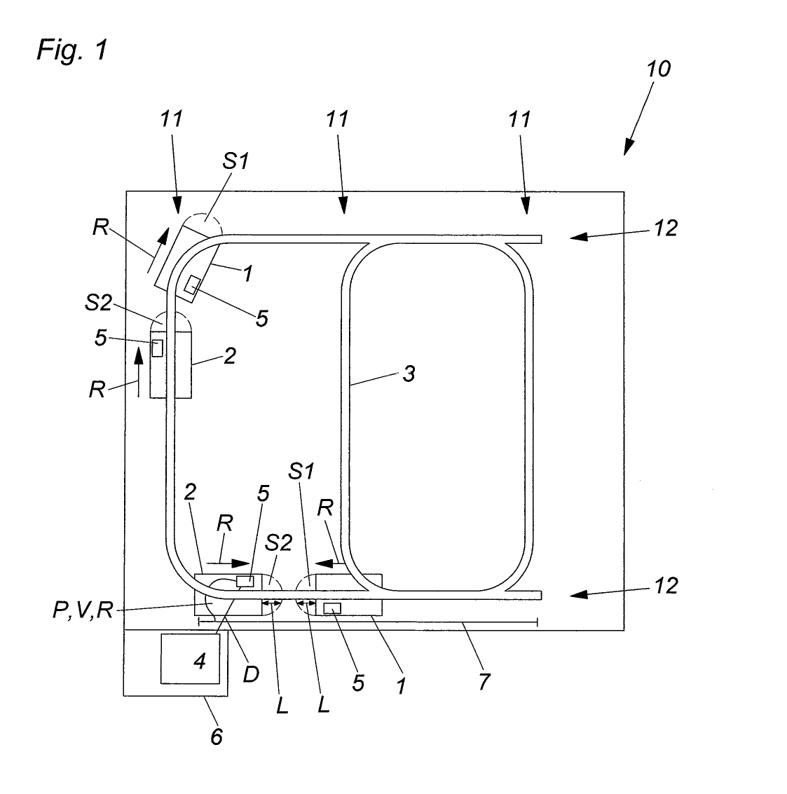

FIG. 1 diagrammatically shows a rack storage system with a logistics installation,

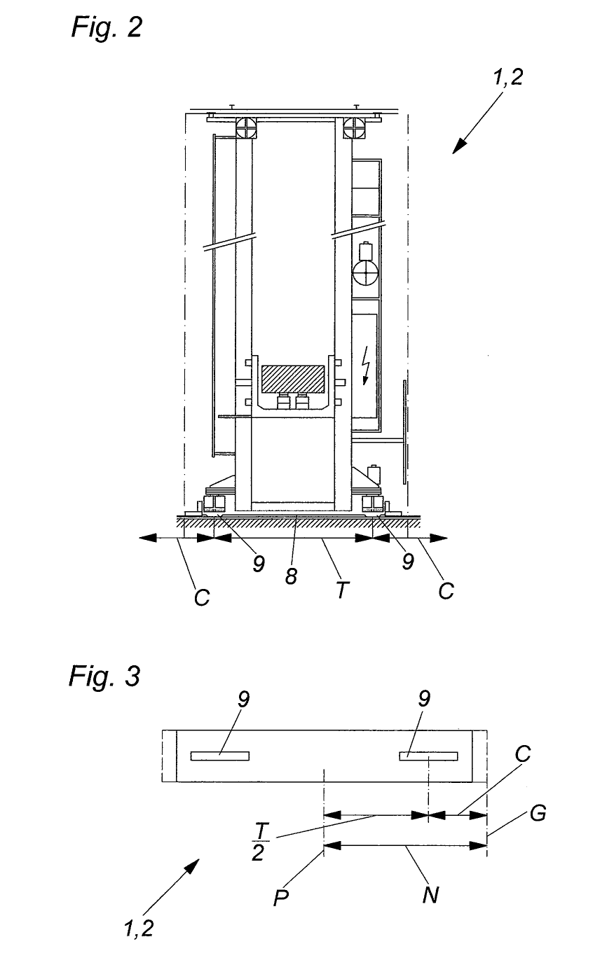

FIG. 2 shows a view of a conveyor vehicle,

FIG. 3 shows a plan view of a conveyor vehicle,

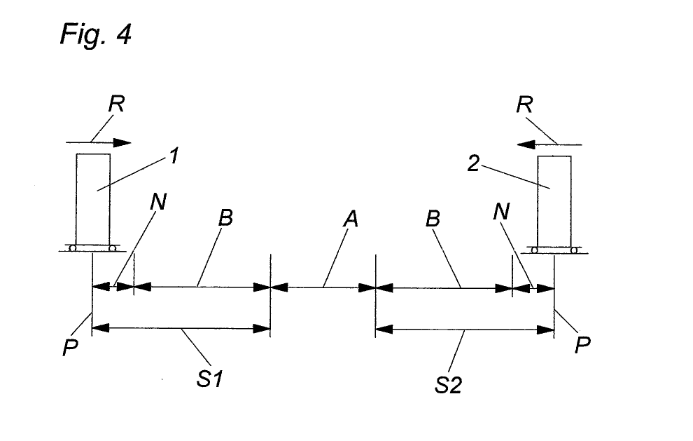

FIG. 4 shows two conveyor vehicles at spacings relative to each other,

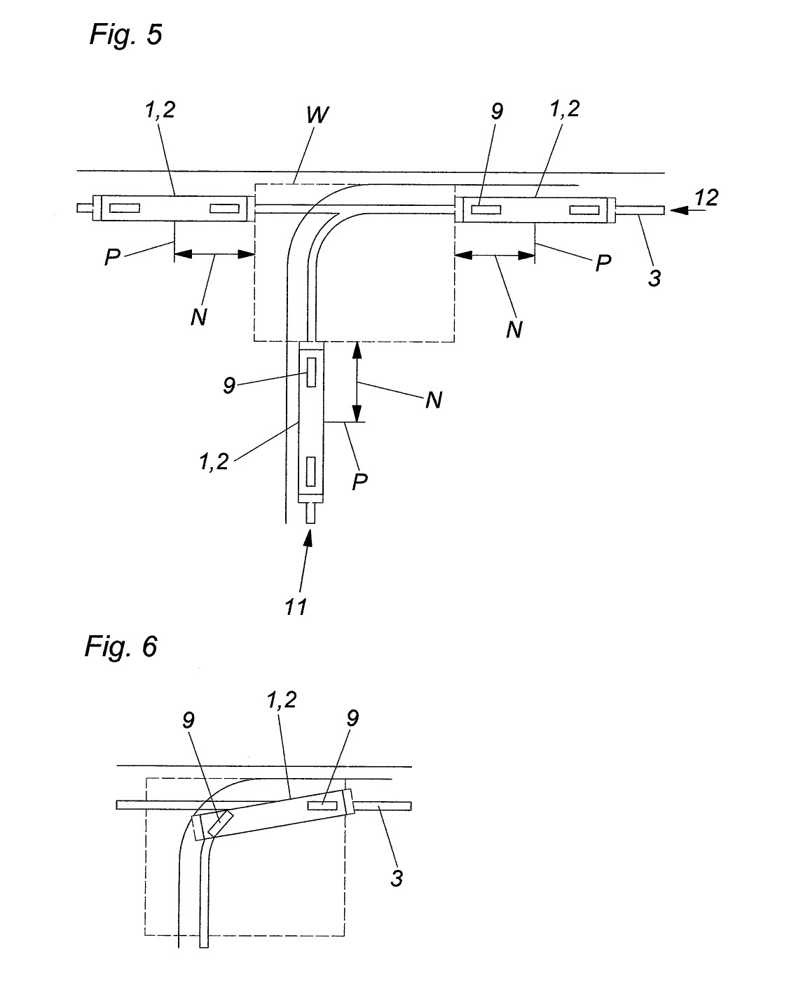

FIG. 5 shows three conveyor vehicles outside a switching points region and

FIG. 6 shows a conveyor vehicle in a switching points region.

FIG. 1 shows a rack storage system 10 in which a reference section 3 comprising rails is arranged. In this arrangement the reference section 3 is guided in three rack aisles 11 and two change aisles 12. The transition between the change aisles 12 and the rack aisles 11 is formed in each case by a switching points region W. Four conveyor vehicles 1 and 2 are displaced in this rack storage system 10. In this case, the great advantage of the present invention is already apparent in the top left region, whereby a second conveyor vehicle 2 can follow very closely behind a first conveyor vehicle 1 as they cannot impede each other and no blocking procedure is necessary. In the case of both conveyor vehicles 1 and 2 the blocked region S1 and S2 respectively is in front of the conveyor vehicles 1 and 2 in the direction of movement R, whereby there is no mutual movement impediment.

In contrast the conveyor vehicles 1 and 2 are moving towards each other in the lower region of FIG. 1. The direction of movement R like also the position P and the speed V are measured or calculated by way of the measuring system 7 and passed in the form of signals to the device 5 which is integrated into the conveyor vehicles 1 and 2 respectively for determining the direction of movement R of the conveyor vehicles 1 and 2. That device 5 is a logic component of the control device 4 to which the device 5 passes the corresponding signals D. The control device 4 (control or regulating unit) is arranged in the control cabinet 6 and sends, in part in cable-less fashion, control commands to the individual conveyor vehicles 1 and 2 respectively. The blocking regions S1 and S2 are afforded for each conveyor vehicle 1 and 2 from the calculation of the control device 4, wherein the length L of those blocking regions S1 and S2 is in dependence on the measured speed V of the individual conveyor vehicles 1 and 2. When conveyor vehicles 1 and 2 move towards each other, as shown in the lower region in FIG. 4, a speed reduction of the two conveyor vehicles 1 and 2 can firstly take place. Upon overlapping of the blocked regions S1 and S2 the two conveyor vehicles 1 and 2 are stopped.

FIG. 2 shows a conveyor vehicle 1 or 2 in the form of a rack servicing device which has wheels 9 guided on rails 8. In this case the wheels 9 are at a wheel spacing T relative to each other. Disposed in front of and behind those wheels 9 is a respective safety distance or margin C. For monitoring the conveyor vehicles 1 and 2 in the safety program the actual position P and the actual speed V inclusive of direction R are required. In the stopped condition the conveyor vehicle 1 or 2 occupies in both directions a region which is formed from half the wheel spacing T/2 and the safety margin C away from the conveyor vehicle (measured from the wheel center point). When designing the safety margin C not only is the furthest projecting part relevant, but also an additional reserve is added thereto (see FIG. 3). That gives the limit point G corresponding to the normal safety margin N.

When the conveyor vehicle is set in movement the required collision safeguard region is increased by the braking travel B in the respective direction R (see FIG. 4). The spacing A between the blocked regions S1 and S2 is shown in FIG. 4. The braking travel B is composed of the reaction travel and the mechanical braking travel. The time of the reaction travel depends on the following factors:
the read-in time in respect of travel measurement in the conveyor vehicle control,
interrupt time of the conveyor vehicle control,
communication timeout from the conveyor vehicle to the control device,
interrupt time of the control device,
communication timeout from the control device to the conveyor vehicle,
interrupt time of the conveyor vehicle control,
reaction time of the emergency braking protection, and
application time of the emergency brake.

There is a reaction time in the tenths-of-a-second or in the seconds range and has effect at maximum speed with quite a few meters.

To permit collision-free movement of the individual conveyor vehicles 1 and 2 each conveyor vehicle 1 and 2 is controlled with each other one. If two conveyor vehicle regions (naturally inclusive of the braking travel B) overlap then there is a collision region. However the reaction to the collision is triggered only when a conveyor vehicle 1 or 2 moves towards another one. In that way it is possible that the conveyor vehicles 1 and 2 can readily move away from each other. Naturally all other conveyor vehicles 1 and 2 may continue to travel without problems.

FIGS. 5 and 6 show a switching points region W of a rack storage system C. In FIG. 5 the top left vehicle 1 and 2 is in such a position that another conveyor vehicles 1 or 2 could readily travel into or out of the rack aisle 11. The lower one of the illustrated conveyor vehicles 1 and 2 is so positioned that another conveyor vehicle 1 or 2 can readily move past in the change aisle 12. As soon as a conveyor vehicle 1 or 2 is in the switching points region W that switching points region W is blocked for other conveyor vehicles 1 and 2. The switching points region W should be selected of such a large size that it is possible without any problem for conveyor vehicles 1 and 2 to pass in, pass out and move past.

In FIG. 6 the conveyor vehicle 1 and 2 is in the curve region of a switching points arrangement of the reference section 3.

The switching points region constitutes the following problem: if an RSD (rack servicing device) travels from a rack aisle into the change aisle that requires a defined region in which the RSD can continue to move without another RSD being on a collision course therein. That region is the switching points region.

In regard to points switching the limit value of the switching points region is initially specified as a stop point. The RSD moves to the start of the switching points region. When the RSD passes into the reserve region of the switching points region, a check is made as to whether the RSD may pass into the switching points region. It is only after confirmation that the RSD moves into the switching points region. There the check region for the RSD changes for from now on it has to check the region to be moved into, for possible obstacles. The reserve region is selected to be of such a size that an RSD could pass through the free switching points region without jerking. If an RSD is on a curve in the switching points region no other one may travel thereinto. In contrast thereto up to two RSDs may come together on the straight section in the switching points region, but then no RSD may pass into the curve. The position of the switching points arrangement in the software thus has nothing at all to do with its real position. 3

1-14. (canceled)

15. A logistics installation for a rack storage system, the installation comprising:
at least a first conveyor vehicle and a second conveyor vehicle each configured to travel along a reference section, the reference section having at least one switching points region;
a control device by which a given region of the reference section can be blocked for travel by said second conveyor vehicle in dependence on a measured position of said first conveyor vehicle along said reference section, wherein when said first conveyor vehicle travels into said switching points region, said switching points region is blocked for said second conveyor vehicle; and
a device for determining a direction of movement of said first and second conveyor vehicles and for transmitting a signal, representing the direction of movement of said first and second conveyor vehicles, to said control device, wherein the region blocked for the second conveyor vehicle is established by said control device with regard to the signal representing the direction of movement of said first conveyor vehicle.

16. The logistics installation according to claim 15, wherein the reference section is completely blocked for travel by said second conveyor vehicle in dependence on the measured position of said first conveyor vehicle.

17. The logistics installation according to claim 15, wherein the region blocked for the second conveyor vehicle in the switching points region is a variable region to be varied in dependence on the signal representing the direction of movement of the first conveyor vehicle.

18. The logistics installation according to claim 17, wherein the region blocked for the second conveyor vehicle may be varied by reducing the region in size.

19. The logistics installation according to claim 15, wherein the given blocked region lies before a first rack servicing device in a direction of movement.

20. The logistics installation according to claim 15, wherein said control device is disposed in a stationary control cabinet.

21. The logistics installation according to claim 15, comprising a measuring system configured for measuring a position of the respective said conveyor vehicles along said reference section.

22. The logistics installation according to claim 21, wherein the direction of movement of said first conveyor vehicle is ascertained from at least two positions of said first conveyor vehicle successively measured by said measuring system.

23. The logistics installation according to claim 15, wherein the direction of movement of said first conveyor vehicle is ascertained from at least two, successively measured positions of said first conveyor vehicle.

24. The logistics installation according to claim 15, wherein said device for determining the direction of movement of said conveyor vehicles is a logic component of said control device.

25. The logistics installation according to claim 15, wherein said control device is configured to calculate a speed of said first conveyor vehicle from at least two positions of said first conveyor vehicle, that are measured in succession at regular time intervals, and to calculate a length of the given blocked region in dependence on the calculated speed.

26. The logistics installation according to claim 25, wherein the speed of said first conveyor vehicle is measured, and the at least two positions of said first conveyor vehicle are measured in succession at regular time intervals by a measuring system.

27. The logistics installation according to claim 21, wherein said measuring system is configured to continuously measure the position of each said conveyor vehicle.

28. The logistics installation according to claim 27, wherein said measuring system is configured to measure the position continuously in the millisecond range.

29. The logistics installation according to claim 15, wherein the reference section includes at least one rack aisle and at least one change aisle and wherein said switching points region connects said rack aisle and said change aisle.

30. A rack storage system, comprising the logistics installation according to claim 15.

31. The rack storage system according to claim 30, configured as a high-bay rack storage system.

32. A method of controlling a movement of conveyor vehicles in a logistics installation, the method which comprising the following steps, to be carried out by a control device:
measuring a position of a first conveyor vehicle along a reference section;
measuring or calculating a direction of movement of the first conveyor vehicle along the reference section;
depending on the direction of movement of the first conveyor vehicle, blocking a region along the reference section for a second conveyor vehicle; and
blocking a switching points region of the reference section for the second conveyor vehicle when a first conveyor vehicle is already in the switching points region.

33. The method according to claim 32, which comprises also blocking a region along the reference section in dependence on a speed of at least one conveyor vehicle.

34. The method according to claim 32, which comprises, in dependence on the direction of movement and a speed of both conveyor vehicles, blocking a region along the reference section in front of the respective conveyor vehicle, and triggering a reduction in a travel speed of the conveyor vehicles upon an approach to the regions or mutual blocking of the regions if an overlap between the regions of both conveyor vehicles is determined.
